(19) United States
(12) Patent Application Publication
(10) Pub. No.: US 2012/0023759 A1
(43) Pub. Date: Feb. 2, 2012

(54) Non-stick knife

(76) Inventor: Qingyi Meng, Beijing (CN)

(21) Appl. No.: 13/136,112

(22) Filed: Jul. 22, 2011

(30) Foreign Application Priority Data
Jul. 29, 2010 (CN) 201020275354.4

(51) Int. Cl. B26B 3/00

(52) U.S. Cl. 30/308

(57) ABSTRACT

A non-stick knife for daily use comprises a handle; a metal piece attached to the handle; a wavy blade on the upper edge of the metal piece at the distal-end from the handle, with the section of the wavy blade being a wedge; a second blade at the bottom of the metal piece, with an arc shape part at the near-handle end for bone chopping; a crimped isolation groove above the center of the second blade on one side of the metal piece; and a slide for separating the materials which the knife cuts from the crimped isolation groove. This knife has the improved features of non-stick, bone cutting and chopping compared with the regular knives.

### TECHNICAL FIELD

This invention relates to a multi-functional knife for daily use, and belongs to kitchenwares.

### BACKGROUND OF THE INVENTION

The regular knifes have a single function of cutting soft and loose food materials, such as vegetables and meat, etc. The blade could be easily damaged or worn when cutting hard food, such as bones and ribs. Moreover, when cutting vegetables with regular knives, the scrap of the vegetables tend to stick to the blade, and as a result, the cut vegetables are disordered and scatter all over the place.

### BRIEF SUMMARY OF THE INVENTION

This invention is a non-stick knife with improved structures so that it not only cuts soft food, but also cuts hard food such as bones. The cut vegetables scrap does not tend to stick to the blade and lines up in order.

This non-stick mainly comprising a handle; a metal piece attached to said handle; a wavy blade on the upper edge of said metal piece at the distal-end from said handle, with the section of said wavy blade being a wedge; a second blade at the bottom of the metal piece, with an arc shape part at the near-handle end for bone chopping; a crimped isolation groove above the center of the second blade on one side of the metal piece; and a slide for separating the materials which the knife cuts above said crimped isolation groove.

This knife has several features improved from regular kitchen knifes, including vegetables and bones cutting; bones chopping; non-stick; the cut material lining up in order; and it is easy to use.

### BRIEF DESCRIPTION OF THE DRAWINGS

FIG. 1 is the diagram of the structure of this invention, the non-stick knife.

FIG. 2 is the enlarged view of the A-A in FIG. 1.

FIG. 3 is the enlarged view of the B-B in FIG. 1.

### DETAILED DESCRIPTION OF THE INVENTION

This invention is a non-stick knife with improved structures so that it not only cuts soft food, but also cuts hard food such as bones. The cut vegetables scrap does not tend to stick to the blade and lines up in order.

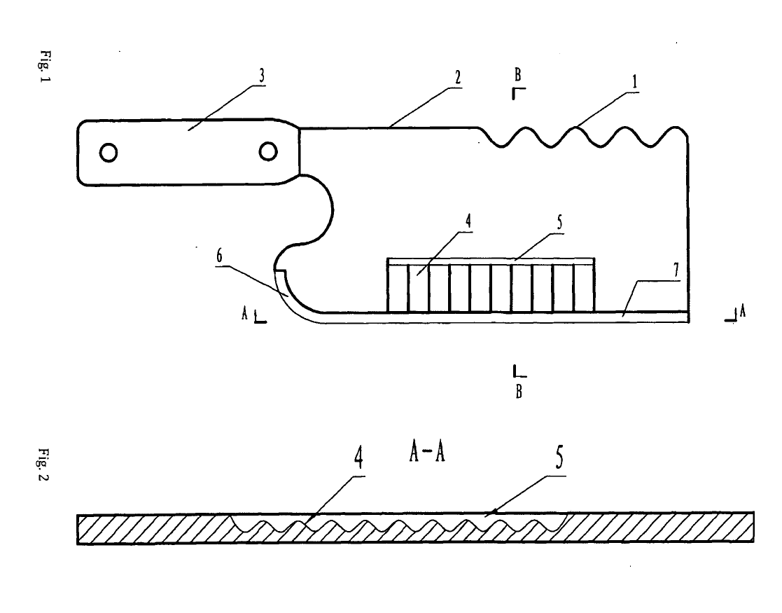

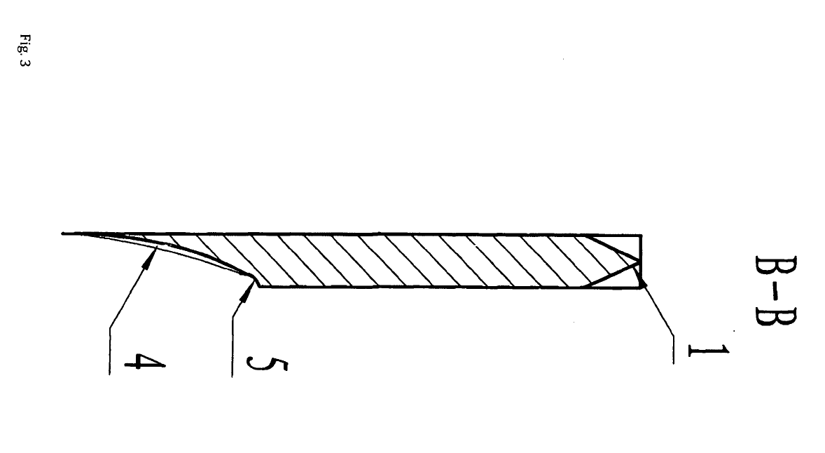

This non-stick knife shown in FIG. 1 comprises comprises a metal piece (2) and a handle (3). There is a wary blade (1) at the upper part of the metal piece (2). The wary blade 1 is as shown in FIG. 3. Its section is a wedge. On one side of the metal piece (2), there is crimped isolation groove (4) at the upper part of a second blade (7) in the center as shown in FIG. 2. At the upper end of the isolation groove (4) there is a slide (5) for separating the materials from the metal piece (2), as shown in FIG. 3. The arc part 6 of the second blade (7) is used for chopping the bones.

When cutting vegetables, a dot-line contact forms between the vegetable and the isolation groove (4). The cut material is separated from the blade (2) and falls down after passing the separating slide (5) at the upper part of the isolation groove (4), and stacks in order. Therefore this knife prevents materials from sticking to the blade due to a large contact surface. Afterward, the cut material is separated by passing the slide on top of the isolation groove, and the material falls down and stacks in order. However, when using regular knifes, the materials will stick to the blade with the upward movement of the knife and scatters all over the place. When cutting small ribs, the arc-shaped blade (6) will be used. The forces concentrate at the arc part, so the ribs could be easily cut off. When chopping bones, the wary shaped blade (1) should be used. The forces concentrate at the top of the wary shaped blade and generate a pressure which is big enough to chop off the bones. The section of the wary blade is a wedge, so that the wary-shaped blade does not easily damage and this helps extends the service life of the knife. When cutting ribs having both soft and hard materials, the arc part of the second blade should be used. The forces concentrate at the arc part, so the ribs will be easily cut off.

In the above mentioned non-stick knife, the outer contour of the wavy shaped blade could be crimped, zigzag or fold line.

The shape of the metal piece attached to the handle is not limited to as shown the drawings.

This knife has several features improved from regular kitchen knifes, including vegetables and bones cutting; bones chopping; non-stick; the cut material lining up in order; and it is easy to use.

### BEST MODE FOR CARRYING OUT THE INVENTION

The best mode for this non-stick knife is explained according to the drawings and the detailed description for using this invention as follows:

The non-stick knife shown in FIG. 1 comprises a metal piece (2) and a handle (3). There is a wary blade (1) at the upper part of the metal piece (2). The wary blade 1 is as shown in FIG. 3. Its section is a wedge. On one side of the metal piece (2), there is crimped isolation groove (4) at the upper part of a second blade (7) in the center as shown in FIG. 2. At the upper end of the isolation groove (4) there is a slide (5) for separating the materials from the metal piece (2), as shown in FIG. 3. The arc part 6 of the second blade (7) is used for chopping the bones.

When cutting vegetables, a dot-line contact forms between the vegetable and the isolation groove (4). The cut material is separated from the blade (2) and falls down after passing the separating slide (5) at the upper part of the isolation groove (4), and stacks in order. When cutting small ribs, the arc-shaped blade (6) will be used. The forces concentrate at the arc part, so the ribs could be easily cut off. When chopping bones, turn the knife upside down and use the wary shaped blade (1). The forces concentrate at the top of the wary shaped blade and generate a pressure which is big enough to chop off the bones. The section of the wary blade is a wedge, so that the wary-shaped blade does not easily damage and this helps extends the service life of the knife.

1. A non-stick knife comprising
a handle;
a metal piece attached to said handle;
a wavy blade on the upper edge of said metal piece at the distal-end from said handle, with the section of said wavy blade being a wedge;
a second blade at the bottom of the metal piece, with an arc part at the near-handle end;
a crimped isolation groove above the center of the second blade on one side of the metal piece; and
a slide above said crimped isolation groove for separating the materials the knife cuts from the second blade.

2. A non-stick knife as in claim 1, wherein the outer contour of the wavy shaped blade is crimped, zigzag or folded line.
